(19) United States
(12) Patent Application Publication
(10) Pub. No.: US 2025/0391396 A1
(43) Pub. Date: Dec. 25, 2025

(54) SYNTHESIS METHOD OF A VEHICLE SOUND WAVE, SYNTHETIC DEVICE THEREOF, ELECTRONIC DEVICE, AND COMPUTER-READABLE STORAGE MEDIUM

(71) Applicant: AAC Acoustic Technologies (Shanghai) Co., Ltd., Shanghai (CN)

(72) Inventors: Wanli Xu, Shanghai (CN); Xuejing Sun, L.A., CA (US)

(21) Appl. No.: 19/000,579

(22) Filed: Dec. 23, 2024

Related U.S. Application Data
(63) Continuation of application No. PCT/CN2024/101182, filed on Jun. 25, 2024.

(51) Int. Cl. G10K 15/02; G07C 5/02; H04R 3/04

(52) U.S. Cl. CPC G10K 15/02; H04R 3/04; G07C 5/02; H04R 2430/01; H04R 2499/13

(57) ABSTRACT

A synthesis method of a vehicle sound wave, a synthetic device thereof, an electronic device, and a computer-readable storage medium relate are provided. The synthesis method includes acquiring a first sound wave audio sample corresponding to a current driving speed of a vehicle for frequency division processing and frequency conversion processing to obtain processed audio samples in different frequency bands; determining sample proportion information of different frequency bands and overall loudness information according to the current driving speed of the vehicle, generating a to-be-output sound wave audio based on the processed audio samples in different frequency bands, the sample proportion information, and the overall loudness information; and generating at least one synthesized sound wave output instruction sending to at least one in-vehicle loudspeaker based on the to-be-output sound wave audio. The synthesis method enhances a driver's perception on real-time vehicle power, improves driving safety, and improves in-vehicle sound quality.

### TECHNICAL FIELD

The present disclosure relates to a field of speech processing technology and is applied to a virtual sound wave output scenario of new energy vehicles. Specifically, the present disclosure relates to a synthesis method of a vehicle sound wave, a synthetic device thereof, an electronic device, and a computer-readable storage medium.

### BACKGROUND

With continuous development of automobile industry, a trend of new energy vehicles replacing orthodox fuel vehicles is irreversible. The new energy vehicles are not powered by orthodox internal combustion engines, so the new energy vehicles do not produce an engine sound of the orthodox fuel vehicles during driving. However, if a driver does not receive any perceptible signal feedback related to a real-time power output level of a new energy vehicle during driving, driving safety is affected to a certain extent. In addition, lack of the engine sound does not meet a requirement of the driver on in-vehicle sound quality.

It is noted that technologies described in the section are not necessarily technologies that have been conceived or adopted before. Unless otherwise specified, it should not be assumed that any technology described in the section is considered to be prior art simply because it is comprised in the section. Similarly, unless otherwise specified, issues mentioned in the section should not be considered to have been recognized in any prior art.

### SUMMARY

The present disclosure provides a synthesis method of a vehicle sound wave, a synthetic device thereof, an electronic device, and a computer-readable storage medium, to solve at least one of technical problems in related art to a certain extent.

To solve the above technical problems, in a first aspect, the present disclosure provides a synthesis method of a vehicle sound wave. The synthesis method comprises steps:

acquiring a first sound wave audio sample corresponding to a current driving speed of a vehicle for frequency division processing and obtaining second sound wave audio samples in different frequency bands;
respectively performing frequency conversion processing on the second sound wave audio samples to obtain processed audio samples in different frequency bands;
determining sample proportion information of different frequency bands according to the current driving speed of the vehicle, and determining overall loudness information according to the current driving speed of the vehicle;
generating a to-be-output sound wave audio based on the processed audio samples in different frequency bands, the sample proportion information, and the overall loudness information; and
generating at least one synthesized sound wave output instruction based on the to-be-output sound wave audio, and sending the at least one synthesized sound wave output instruction to at least one in-vehicle loudspeaker.

The at least one synthesized sound wave output instruction is configured to control the at least one in-vehicle loudspeaker to play the to-be-output sound wave.

In a second aspect, the present disclosure provides a synthesis device of a vehicle sound wave. The synthesis device comprises a sample acquisition module, a frequency conversion processing module, an information determination module, an audio generation module, and an output control module.

The sample acquisition module is configured to acquire a first sound wave audio sample corresponding to a current driving speed of a vehicle for frequency division processing to obtain second sound wave audio samples in different frequency bands.

The frequency conversion processing module is configured to respectively perform frequency conversion processing on the second sound wave audio samples to obtain processed audio samples in different frequency bands.

The information determination module is configured to determine sample proportion information of different frequency bands according to the current driving speed of the vehicle, and determining overall loudness information according to the current driving speed of the vehicle.

The audio generation module is configured to generate a to-be-output sound wave audio based on the processed audio samples in different frequency bands, the sample proportion information, and the overall loudness information.

The output control module is configured to generate at least one synthesized sound wave output instruction based on the to-be-output sound wave audio and send the at least one synthesized sound wave output instruction to at least one in-vehicle loudspeaker. The at least one synthesized sound wave output instruction is configured to control the at least one in-vehicle loudspeaker to play the to-be-output sound wave.

In a third aspect, the present disclosure provides an electronic device. The electronic device comprises a memory and at least one processor. The at least one processor is configured to execute computer programs stored in the memory. The at least one processor executes the computer programs to implement the steps of the synthesis method mentioned above.

In a fourth aspect, the present disclosure provides a computer-readable storage medium. The computer-readable storage medium comprises computer programs stored therein. The computer programs are executed by at least one processor to implement the steps of the synthesis method mentioned above.

In the synthesis method of the vehicle sound wave, the synthetic device thereof, the electronic device, and the computer-readable storage medium of the present disclosure, the first sound wave audio sample corresponding to the current driving speed of the vehicle for frequency division processing is acquired, the second sound wave audio samples in different frequency bands are obtained, the frequency conversion processing is respectively performed on the second sound wave audio samples to obtain the processed audio samples in different frequency bands, the sample proportion information of different frequency bands is determined according to the current driving speed of the vehicle, the overall loudness information is determined according to the current driving speed of the vehicle, the to-be-output sound wave audio is generated based on the processed audio samples in different frequency bands, the synthesized sound wave output instructions is generated based on the to-be-output sound wave audio, the synthesized sound wave output instructions are sent to in-vehicle loudspeakers. Through an implementation of the present disclosure, the first sound wave audio sample is obtained according to the current driving speed, and then the frequency division processing, the frequency conversion processing, and a loudness changing processing are performed, then the in-vehicle loudspeakers are controlled to output simulated sound audio, which enhances perception of a driver on real-time power of the vehicle, improves driving safety, and further improves in-vehicle sound quality.

It should be understood that contents described in the section is not intended to identify the key or important features of the present disclosure, nor is it intended to limit the scope of the present disclosure. Other features of the present disclosures will become easily understood through following description.

### BRIEF DESCRIPTION OF DRAWINGS

Accompanying drawings exemplarily illustrate embodiments and constitute a part of the specification. The accompanying drawings, together with the description of the specification, are configured to explain exemplary implementations of the embodiments. The drawings shown are for illustrative purposes only and do not limit the scope of the claims. In all drawings, the same reference numerals refer to similar but not necessarily identical elements.

FIG. 1 is a flow chart of a synthesis method of a vehicle sound wave according to one embodiment of the present disclosure.

FIG. 2 is a schematic diagram of pitch interpolation at different driving speeds according to one embodiment of the present disclosure.

FIG. 3 is a schematic diagram showing a relationship between a driving speed and loudness according to one embodiment of the present disclosure.

FIG. 4 is a schematic diagram showing a relationship between a torque and the loudness according to one embodiment of the present disclosure.

FIG. 5 is a schematic diagram showing a principle of fade-in and fade-out processes of to-be-output sound wave audios according to one embodiment of the present disclosure.

FIG. 6 is another flow chart of the synthesis method of the vehicle sound wave according to one embodiment of the present disclosure.

FIG. 7 is a schematic diagram of functional module of a synthesis device of the vehicle sound wave according to one embodiment of the present disclosure.

FIG. 8 is a schematic diagram of an electronic device according to one embodiment of the present disclosure.

### DETAILED DESCRIPTION

In order to make objectives, features, and advantages of the present disclosure clear, technical solutions in the embodiments of the present disclosure will be described clearly and completely in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be understood in the description of the present disclosure that terms such as “first” and “second” are only used for the purpose of description, rather than being understood to indicate or imply relative importance or hint the number of indicated technical features. Thus, the feature limited by “first” and “second” can explicitly or impliedly comprise one or more features. The meaning of “a plurality of” is two or more unless otherwise specified. The term “comprise” indicates the existence of features, integers, steps, operations, units, components, and/or combinations thereof and intends to cover non-exclusive inclusion, which may exist or add one or more other features, integers, steps, operations, units, components, and/or combinations thereof. The term “and/or” depict relationship between associated objects and there are three relationships thereon. For example, A and/or B may indicate A exists alone, A and B exist at the same time, and B exists alone. The character “/” generally indicates that the associated object is alternative. The terms “first”, “second”, “third”, etc. in the present disclosure are used only to distinguish similar objects and do not imply a specific ordering of objects.

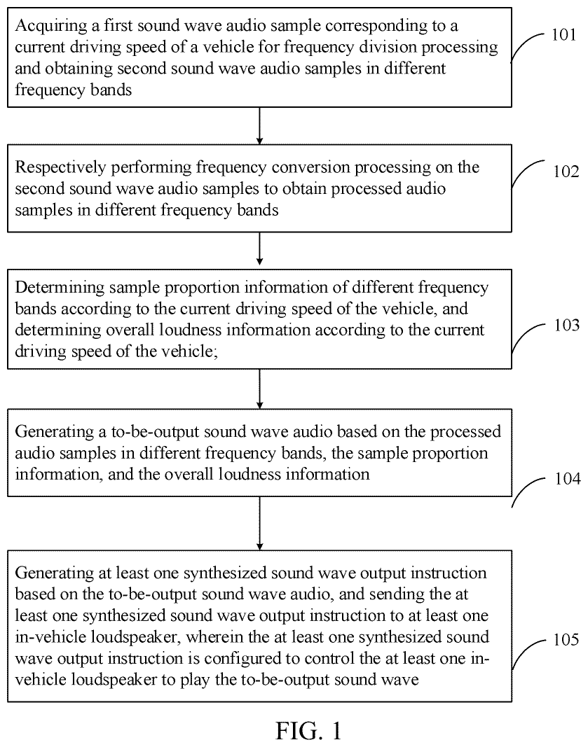

In order to solve a problem of driving safety and reduced in-vehicle sound quality caused by lack of perceptible signals related to a real-time power output level of new energy vehicles in the related art, one embodiment of the present disclosure provides a synthesis method of a vehicle sound wave, which is applied to a vehicle terminal of a new energy vehicle or a mobile terminal of a driver. As shown in FIG. 1, FIG. 1 is a flow chart of the synthesis method of the vehicle sound wave according to one embodiment of the present disclosure. The synthesis method comprises steps 101-105.

The step 101 comprises acquiring a first sound wave audio sample corresponding to a current driving speed of a vehicle for frequency division processing and obtaining second sound wave audio samples in different frequency bands.

Specifically, in the embodiment, sound wave audio samples of a fuel vehicle at different speeds are recorded in advance. For instance, an in-vehicle sound of the fuel vehicle when idling, and in-vehicle sounds of the fuel vehicle driving at speeds of 10 km/h, 20 km/h, 30 km/h, . . . , 90 km/h are recorded to obtain a sound wave audio sample X, and an in-vehicle sound of the fuel vehicle when the fuel vehicle is slowly and evenly accelerated is recorded to obtain a sound wave audio sample X1. When recording the sound wave audio samples, a recording position is at an engine of the fuel vehicle. In the embodiment, the first sound wave audio sample is obtained according to the current driving speed of the vehicle, and then the first sound wave audio sample is divided to obtain the second sound wave audio samples in different frequency bands. The second sound wave audio samples in different frequency bands are divided according to different frequency levels. For example, the frequency levels comprise an ultra-low frequency band (0-300 Hz), a low frequency band (300-2500 Hz), a mid-frequency band (2500-5000 Hz), and a high frequency band (5000-10000 Hz).

In some embodiment of the present disclosure, the step of acquiring the first sound wave audio sample corresponding to the current driving speed of the vehicle for frequency division processing comprises acquiring the first sound wave audio sample corresponding to the current driving speed of the vehicle; calculating a primary order frequency of the first sound wave audio sample; and performing the frequency division processing on the first sound wave audio sample based on the primary order frequency.

The step 102 comprises respectively performing frequency conversion processing on the second sound wave audio samples to obtain processed audio samples in different frequency bands.

Optionally, in the embodiment, target pitch information corresponding to the current driving speed is determined according to a predetermined first positive proportional function, and the frequency conversion processing is performed on the second sound wave audio samples based on the target pitch information to obtain the processed audio samples in different frequency bands.

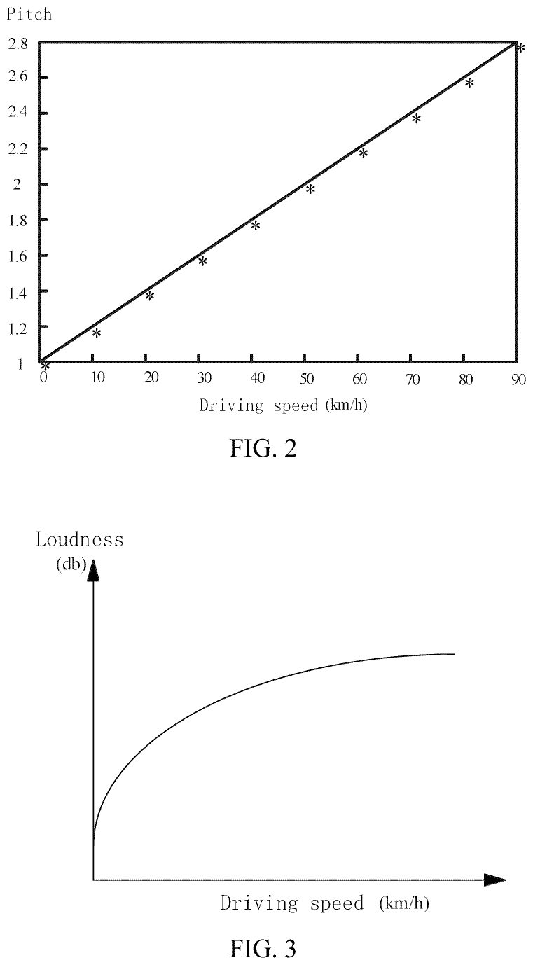

As shown in FIG. 2, FIG. 2 is a schematic diagram of pitch interpolation at different driving speeds according to one embodiment of the present disclosure.

Frequencies of primary orders (2nd order) of sounds of different speeds in the sound wave audio sample X are calculated and are respectively recorded as F0-F9. A pitch corresponding to F0 is represented by pitch=1.0, and pitch(i)=Fi/F0. A pitch of each of the sounds in different speeds is a linear interpolation between pitch(i) and pitch(i+1), which maintains continuity of the frequencies and avoid pop sounds caused by frequency discontinuity. In the embodiment, an index is represented by index=floor(v/10), pitch=pitch(index)*(index+1−v/10)+pitch(index+1)*(v/10−index). Then, based on calculated pitches of the sounds, the frequency conversion processing is performed on the second sound wave audio samples.

In some embodiments of the present disclosure, before the step of respectively performing the frequency conversion processing on the second sound wave audio samples to obtain the processed audio samples in different frequency bands, the synthesis method further comprises respectively performing amplitude normalization processing on the second sound wave audio samples, and respectively fading in and fading out a head portion and a tail portion of each of the second sound wave audio samples after the amplitude normalization processing.

Specifically, in practical applications, the head portion and the tail portion of each of the second sound wave audio samples is faded in and out to ensure the continuity of the head portion and the tail portion of each of the second sound wave audio samples and avoid the pop sounds caused by discontinuity in a time domain.

The step 103 comprises determining sample proportion information of different frequency bands according to the current driving speed of the vehicle, and determining overall loudness information according to the current driving speed of the vehicle.

Specifically, in the embodiment, it is necessary to record a proportional relationship of sound wave audio samples in different frequency bands at different driving speeds within a specific speed range. In practical applications, the proportional relationship is queried according to the current driving speed of the vehicle to obtain the sample proportion information of different frequency bands at the current driving speed. In addition, in the embodiment, a correlation relationship between loudness and the driving speed is pre-configured. Based on the correlation relationship, the current driving speed is served as an independent variable to determine the overall loudness information corresponding to the current driving speed.

In some embodiments of the present disclosure, the step of determining the overall loudness information according to the current driving speed of the vehicle comprises determining first loudness information corresponding to the current driving speed according to a predetermined second positive proportional function, and when the current driving speed is greater than a predetermined speed threshold, determining the overall loudness information based on torque information and the first loudness information.

It should be noted that the predetermined speed threshold may be 0. That is, in practical applications, as long as the vehicle has the driving speed and is in a driving state, the overall loudness information is determined based on the torque and the driving speed. Optionally, a value of the predetermined speed threshold is a specific value greater than 0. Accordingly, when the current driving speed is not greater than the predetermined speed threshold, the first loudness information is directly determined as the overall loudness information.

As shown in FIG. 3, FIG. 3 is a schematic diagram showing a relationship between the driving speed and loudness according to one embodiment of the present disclosure. It is seen that within a certain speed range, a general situation of loudness changing with the driving speed is that the loudness Amp gradually increases with an increase of the driving speed. That is, a relationship between the driving speed and the loudness is a positive proportional function. Then, within the certain speed range, the current driving speed is configured as an independent variable of the predetermined second positive proportional function, and the first loudness information is configured as a dependent variable that is obtained by substituting a value of the current driving speed into the predetermined positive proportional function. In addition, considering that when the vehicle is driving at a high speed, the loudness of the vehicle sound ware audio may be too loud and cause negative interference to the driver and passengers in the vehicle, therefore, in the embodiment, when the current driving speed is greater than the predetermined speed threshold whose value is greater than 0, the first loudness information associated with the driving speed is adjusted based on the torque information.

In some embodiments of the present disclosure, the step of determining the overall loudness information based on the torque information and the first loudness information comprises determining second loudness information corresponding to the torque information according to a predetermined third positive proportional function, wherein the second loudness information is not greater than 0, and performing summation calculation on the first loudness information and the second loudness information to obtain the overall loudness information.

As shown in FIG. 4, FIG. 4 is a schematic diagram showing a relationship between the torque and the loudness according to one embodiment of the present disclosure. According to FIG. 4, it is noted that a relationship between the torque and the second loudness information is a predetermined third positive proportional function. If the second loudness information as a dependent variable is not greater than 0, then as the torque increases, a value of the calculated second loudness information gradually approaches 0 from a specific negative value. Finally, the second loudness information is added to the first loudness information to obtain the overall loudness information that comprehensively considers the torque and the driving speed.

The step 104 comprises generating a to-be-output sound wave audio based on the processed audio samples in different frequency bands, the sample proportion information, and the overall loudness information.

Specifically, in the embodiment, a ratio of processed audio samples in different frequency bands is adjusted according to the sample proportion information, and generated timbre is no longer restricted by the processed audio samples. In addition, according to the overall loudness information corresponding to the current driving speed of the vehicle calculated previously, the processed audio samples after frequency conversion in different frequency bands are synthesized to generate the to-be-output sound wave audio.

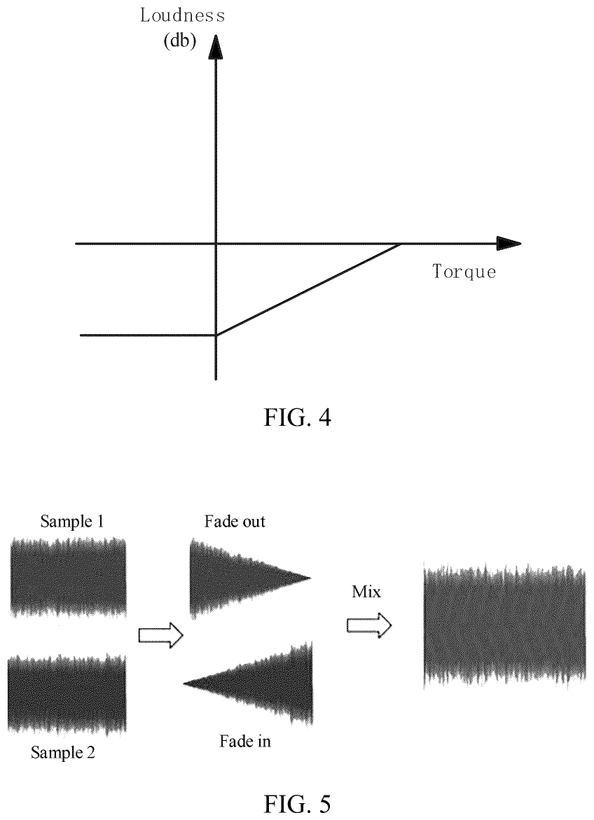

Optionally, in the embodiment, when the sound wave audios corresponding to different driving speeds are continuously output, considering that when the driving speed is at a specific critical value, a short-term explosive sound, i.e., a pop sound, may appear in a sound effect, resulting in a poor sound effect. Therefore, in the embodiment, to-be-output sound wave audios that are continuously output are further processed. A specific processing method is to fade out a current to-be-output sound wave audio at the speed critical value, then fade in a next to-be-output sound wave audio. That is, in a process of continuously outputting the synthesized sound wave audios (i.e., the to-be-output sound wave audios mentioned above), a fade-in process and a fade-out process are alternately performed. As shown in FIG. 5, FIG. 5 is a schematic diagram showing a principle of the fade-in and fade-out processes of to-be-output sound wave audios according to one embodiment of the present disclosure.

For sample 1 and sample 2 of to-be-output sound wave audios that are continuously output, a tail portion of a previous sample (i.e., the sample 1) after the fade-out process is connected with a head portion of a latter sample (i.e., the sample 2) after the fade-in process to ensure continuity of mixed audio signals in the time domain. For example, when the driving speed of the vehicle increases from 9.5 km/h to 10.5 km/h, an to-be-output sound wave audio in an idle state in the samples is faded out, while the to-be-output sound wave audio corresponding to 10 km/h is faded in. The to-be-output sound wave audios corresponding to different driving speeds are connected, and the faded-in process and the fade-out process are alternately performed to avoid pop sounds caused by discontinuity of the time domain.

In some embodiments of the present disclosure, the step of generating the to-be-output sound wave audio based on the processed audio samples in different frequency bands, the sample proportion information, and the overall loudness information comprises respectively determining single-band loudness information corresponding to each of the processed audio samples according to the sample proportion information and the overall loudness information corresponding to different frequency bands; and generating the to-be-output sound wave audio according to the processed audio samples satisfying the sample proportion information and corresponding single-band loudness information.

Specifically, in the embodiment, the sample proportion information of different frequency bands under different driving speeds is determined in advance. For example, proportions of the ultra-low frequency band, the low frequency band, the medium frequency band, and the high frequency band are respectively defined as coe1, coe2, coe3, and coe4, and coe1+coe2+coe3+coe4=1.0. If the overall loudness information is defined as Amp, loudness information of each of the frequency bands is Amp1=Amp*coe1, Amp3=Amp*coe2, Amp3=Amp*coe3, and Amp4=Amp*coe4. Finally, based on the processed audio samples of different frequency bands that meet a specific sample ratio relationship and the loudness information respectively corresponding to the frequency bands, the to-be-output sound wave audio that meets the current driving speed of the vehicle is synthesized.

The step 105 comprises generating at least one synthesized sound wave output instruction based on the to-be-output sound wave audio, and sending the at least one synthesized sound wave output instruction to at least one in-vehicle loudspeaker, wherein the at least one synthesized sound wave output instruction is configured to control the at least one in-vehicle loudspeaker to play the to-be-output sound wave.

The at least one synthesized sound wave output instruction is configured to control the at least one in-vehicle loudspeaker to play the to-be-output sound wave.

Thus, the simulated engine sound of the fuel vehicle is output in a driving space of the new energy vehicle. It is noted that the at least one in-vehicle loudspeaker in the embodiment is at least one loudspeaker configured by the vehicle itself, and the at least one in-vehicle loudspeaker may be a loudspeaker reused by an in-vehicle sound system, or the at least one in-vehicle loudspeaker is a special loudspeaker additionally configured in the vehicle. In addition, a quantity and a location of the at least one in-vehicle loudspeaker are flexibly configured according to an actual application scenario or usage requirements.

In some embodiment of the present disclosure, the at least one synthesized sound wave output instruction comprises synthesized sound wave output instructions, and the at least one in-vehicle loudspeaker comprises in-vehicle loudspeakers. The step of generating the at least one synthesized sound wave output instruction based on the to-be-output sound wave audio and sending the at least one synthesized sound wave output instruction to the at least one in-vehicle loudspeaker comprises correspondingly reconfiguring proportions of the processed audio samples in different frequency bands in the to-be-output sound wave audio according to frequency response characteristic information of the in-vehicle loudspeakers to obtain single-loudspeaker sound wave audios; generating the synthesized sound wave output instructions based on the single-loudspeaker sound wave audios; and simultaneously sending the synthesized sound wave output instructions respectively corresponding to the in-vehicle loudspeakers to the in-vehicle loudspeakers.

In order to further improve the sound quality inside the vehicle, a multi-loudspeaker output method is adopted to output the synthesized sound wave audios. That is, referring to the frequency response characteristics of each of the in-vehicle loudspeakers, the proportion of the audio samples of different frequency bands corresponding to each of the in-vehicle loudspeakers is reallocated, and then the output of the synthesized sound wave audios respectively corresponding to the in-vehicle loudspeakers is controlled accordingly.

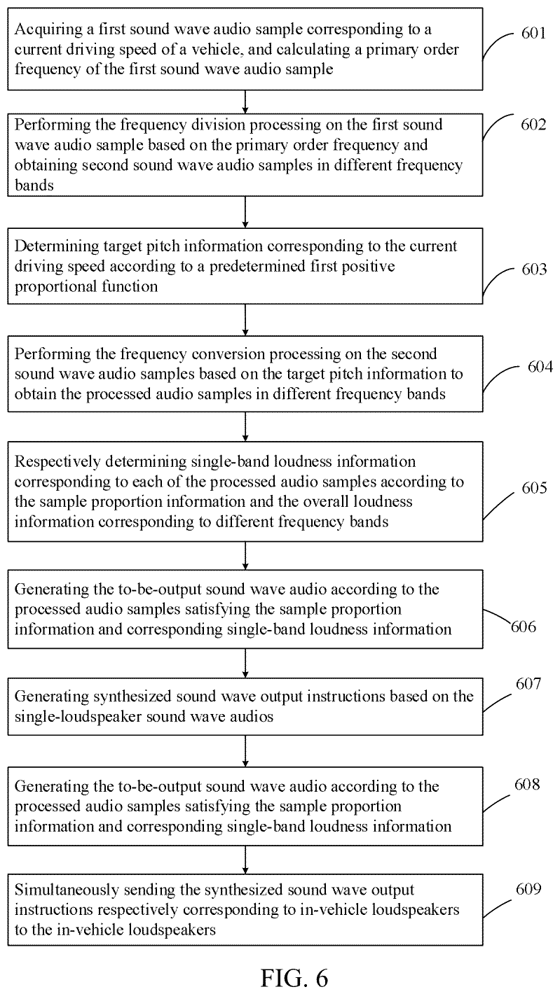

In order to better illustrate implementation schemes of the present disclosure, the present disclosure further provides an optimized synthesis method of the vehicle sound wave. As shown in FIG. 6, FIG. 6 is another flow chart of the synthesis method of the vehicle sound wave according to one embodiment of the present disclosure. The synthesis method comprises steps 601-609.

The step 601 comprises acquiring a first sound wave audio sample corresponding to a current driving speed of a vehicle, and calculating a primary order frequency of the first sound wave audio sample.

The step 602 comprises performing the frequency division processing on the first sound wave audio sample based on the primary order frequency and obtaining second sound wave audio samples in different frequency bands.

The step 603 comprises determining target pitch information corresponding to the current driving speed according to a predetermined first positive proportional function.

The step 604 comprises performing the frequency conversion processing on the second sound wave audio samples based on the target pitch information to obtain the processed audio samples in different frequency bands.

The step 605 comprises determining sample proportion information of different frequency bands according to the current driving speed of the vehicle, and determining overall loudness information according to the current driving speed of the vehicle.

The step 605 comprises respectively determining single-band loudness information corresponding to each of the processed audio samples according to the sample proportion information and the overall loudness information corresponding to different frequency bands.

The step 606 comprises generating the to-be-output sound wave audio according to the processed audio samples satisfying the sample proportion information and corresponding single-band loudness information.

The step 607 comprises correspondingly reconfiguring proportions of the processed audio samples in different frequency bands in the to-be-output sound wave audio according to frequency response characteristic information of the in-vehicle loudspeakers to obtain single-loudspeaker sound wave audios.

The step 608 comprises generating synthesized sound wave output instructions based on the single-loudspeaker sound wave audios.

The step 609 comprises simultaneously sending the synthesized sound wave output instructions respectively corresponding to in-vehicle loudspeakers to the in-vehicle loudspeakers.

It should be understood that serial numbers of the steps in the embodiment do not mean an execution order of the steps. The execution order of the steps should be determined by functions and internal logic thereof, and should not constitute a limitation on an implementation process of the embodiment of the present disclosure.

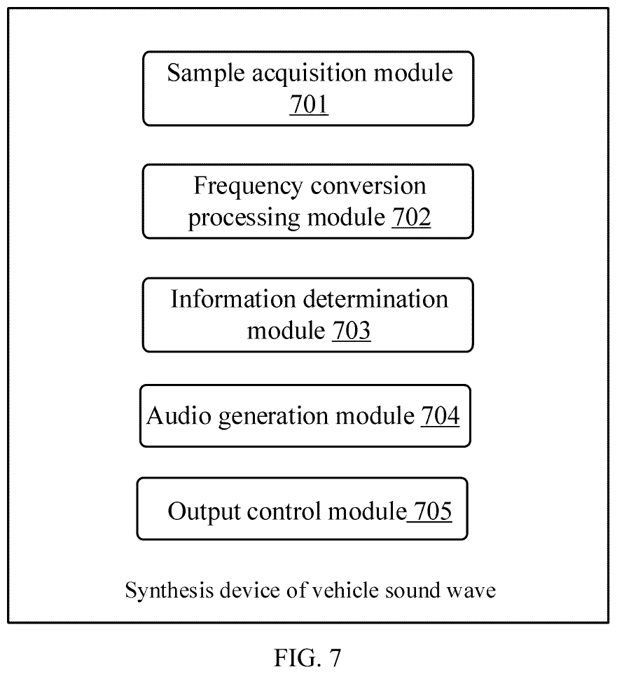

As shown in FIG. 7, FIG. 7 is a schematic diagram of functional module of a synthesis device of the vehicle sound wave according to one embodiment of the present disclosure. The synthesis device of the vehicle sound wave is configured to realize the synthesis method of the vehicle sound wave mentioned above.

The synthesis device comprises a sample acquisition module 701, a frequency conversion processing module 702, an information determination module 703, an audio generation module 704, and an output control module 705.

The sample acquisition module 701 is configured to acquire a first sound wave audio sample corresponding to a current driving speed of a vehicle for frequency division processing to obtain second sound wave audio samples in different frequency bands.

The frequency conversion processing module 702 is configured to respectively perform frequency conversion processing on the second sound wave audio samples to obtain processed audio samples in different frequency bands.

The information determination module 703 is configured to determine sample proportion information of different frequency bands according to the current driving speed of the vehicle, and determining overall loudness information according to the current driving speed of the vehicle.

The audio generation module 704 is configured to generate a to-be-output sound wave audio based on the processed audio samples in different frequency bands, the sample proportion information, and the overall loudness information.

The output control module 705 is configured to generate at least one synthesized sound wave output instruction based on the to-be-output sound wave audio and send the at least one synthesized sound wave output instruction to at least one in-vehicle loudspeaker. The at least one synthesized sound wave output instruction is configured to control the at least one in-vehicle loudspeaker to play the to-be-output sound wave.

In one optional embodiment, the synthesis device further comprises a sample processing module. The sample processing module is configured to perform amplitude normalization processing on second sound wave audio samples and perform fade-in and fade-out processing on a head portion and a tail portion of each of the second sound wave audio samples after the normalization processing respectively.

It should be noted that the synthesis method of the vehicle sound wave in the aforementioned embodiments is able to be implemented based on the synthesis device of the vehicle sound wave provided in the embodiment. An ordinary skilled in the art can clearly understand that for convenience and conciseness of description, a specific working process of the synthesis device described in the embodiment is able to be implemented by referring to corresponding working processes in the aforementioned embodiments, which is not repeatedly described herein.

In the synthesis method of the vehicle sound wave, the synthetic device thereof, the electronic device, and the computer-readable storage medium of the present disclosure, the first sound wave audio sample corresponding to the current driving speed of the vehicle for frequency division processing is acquired, the second sound wave audio samples in different frequency bands are obtained, the frequency conversion processing is respectively performed on the second sound wave audio samples to obtain the processed audio samples in different frequency bands, the sample proportion information of different frequency bands is determined according to the current driving speed of the vehicle, the overall loudness information is determined according to the current driving speed of the vehicle, the to-be-output sound wave audio is generated based on the processed audio samples in different frequency bands, the synthesized sound wave output instructions is generated based on the to-be-output sound wave audio, the synthesized sound wave output instructions are sent to in-vehicle loudspeakers. Through an implementation of the present disclosure, the first sound wave audio sample is obtained according to the current driving speed, and then the frequency division processing, the frequency conversion processing, and a loudness changing processing are performed, then the in-vehicle loudspeakers are controlled to output simulated sound audio, which enhances perception of a driver on real-time power of the vehicle, improves driving safety, and further improves in-vehicle sound quality.

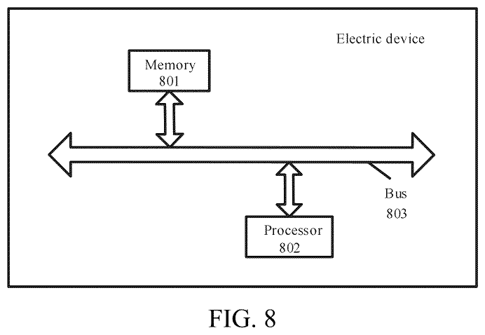

As shown in FIG. 8, FIG. 8 is a schematic diagram of an electronic device according to one embodiment of the present disclosure. The electronic device is configured to implement the synthesis method of the vehicle sound wave in the above-mentioned embodiments.

The electronic device mainly comprises a memory 801, at least one processor 802, and a bus 803. The memory 801 and the at least one processor 802 are connected through the bus 803. The memory 801 stores computer programs that are allowed to be run on the at least one processor 802. When the at least one processor 802 executes the computer programs, the synthesis method in the above embodiments is implemented. The at least one processor may comprise one or more processors.

The memory 801 may be a high-speed random access memory (RAM) memory, or a non-volatile memory, such as a disk memory. The memory 801 is configured to store executable program codes, and the at least one processor 802 is coupled to the memory 801.

Furthermore, the present disclosure further provides a computer-readable storage medium. The computer-readable storage medium may be disposed in the electronic device in the above-mentioned embodiment, and the computer-readable storage medium may be the memory in FIG. 8 of the above-mentioned embodiment.

The computer-readable storage medium stores the computer programs, and when the computer programs are executed by the at least one processor, the synthesis method in the above-mentioned embodiments is implemented. Furthermore, the computer-readable storage medium maybe a USB flash disk, a mobile hard disk, a read-only memory (ROM), the RAM, a magnetic disk, an optical disk, or other medium that is able to store program codes.

In the embodiments of the present disclosure, it should be understood that the disclosed apparatus and method may be implemented in other manners. For example, the apparatus of the embodiments described above are merely illustrative. For example, division of modules is merely a logical function division, and the modules may be divided in other division manners in actual implementation. For example, a plurality of modules or components may be combined or may be integrated into another system, or some features may be ignored or not performed. In addition, the displayed or discussed mutual coupling, direct coupling, or communication connection may be indirect coupling or communication connection through interfaces, devices, or modules, and may be in electrical connection, mechanical connection, or other forms.

The modules described as separate parts may or may not be physically separate, and parts displayed as modules may or may not be physical modules. The modules may be located in one position, or may be distributed on different network modules. Some or all of the modules may be selected according to actual needs to achieve the objectives of the solutions of the embodiments.

In addition, functional modules in the embodiments of the present disclosure may be integrated into one processing module, or each of the modules may exist separately and physically, or two or more modules are integrated into one module. The integrated module may be implemented in a form of hardware, or may be implemented in a form of a software functional module.

When the integrated module is implemented in the form of a software functional module and sold or used as an independent product, the integrated module may be stored in the computer-readable storage medium. Based on such understanding, the technical solution of the present disclosure essentially or all or part of the technical solution that contributes to the prior art may be embodied in the form of a software product, and the software product is stored in the computer-readable storage medium, and comprises instructions for causing a computer device (e.g., a personal computer, a server, or a network device) to perform all or part of the steps of the methods in the embodiments of the present disclosure. The foregoing computer-readable storage medium comprises any medium that can store the program codes, such as the USB flash drive, the mobile hard disk, the ROM, the RAM, the magnetic disk, or an optical disk.

It should be noted that, for the foregoing embodiments of the method, for ease of description, the foregoing embodiments of the method are all expressed as a series of action combinations, but the ordinary skilled in the art should know that the present disclosure is not limited by the sequence of the described actions, because some steps may be performed in other orders or simultaneously according to the present disclosure. In addition, the ordinary skilled in the art should also know that the embodiments described in the specification are all optional embodiments, and the involved actions and modules are not necessarily required in the present disclosure.

In the foregoing embodiments, the description of each of the embodiments has own emphasis, and parts that are not described in detail in one of the embodiments may refer to related descriptions of other embodiments.

The above is a description of the synthesis method of the vehicle sound wave, device, the synthesis device, and the computer-readable storage medium of the present disclosure. For the ordinary skilled in the art, according to the ideas of the embodiments of the present disclosure, there may be changes in the specific implementation methods and application scopes. In summary, the content of the specification should not be understood as a limitation on the present disclosure.

What is claimed is:

1. A synthesis method of a vehicle sound wave, comprising steps:
acquiring a first sound wave audio sample corresponding to a current driving speed of a vehicle for frequency division processing and obtaining second sound wave audio samples in different frequency bands;
respectively performing frequency conversion processing on the second sound wave audio samples to obtain processed audio samples in different frequency bands;
determining sample proportion information of different frequency bands according to the current driving speed of the vehicle, and determining overall loudness information according to the current driving speed of the vehicle;
generating a to-be-output sound wave audio based on the processed audio samples in different frequency bands, the sample proportion information, and the overall loudness information; and
generating at least one synthesized sound wave output instruction based on the to-be-output sound wave audio, and sending the at least one synthesized sound wave output instruction to at least one in-vehicle loudspeaker, wherein the at least one synthesized sound wave output instruction is configured to control the at least one in-vehicle loudspeaker to play the to-be-output sound wave.

2. The synthesis method according to claim 1, wherein the step of acquiring the first sound wave audio sample corresponding to the current driving speed of the vehicle for frequency division processing comprises steps:
acquiring the first sound wave audio sample corresponding to the current driving speed of the vehicle;
calculating a primary order frequency of the first sound wave audio sample; and
performing the frequency division processing on the first sound wave audio sample based on the primary order frequency.

3. The synthesis method according to claim 1, wherein the step of respectively performing the frequency conversion processing on the second sound wave audio samples to obtain the processed audio samples in different frequency bands comprises steps:
determining target pitch information corresponding to the current driving speed according to a predetermined first positive proportional function; and
performing the frequency conversion processing on the second sound wave audio samples based on the target pitch information to obtain the processed audio samples in different frequency bands.

4. The synthesis method according to claim 1, wherein before the step of respectively performing the frequency conversion processing on the second sound wave audio samples to obtain the processed audio samples in different frequency bands, the synthesis method further comprises steps:
respectively performing amplitude normalization processing on the second sound wave audio samples; and
respectively fading in and fading out a head portion and a tail portion of each of the second sound wave audio samples after the amplitude normalization processing.

5. The synthesis method according to claim 1, wherein the step of determining the overall loudness information according to the current driving speed of the vehicle comprises steps:
determining first loudness information corresponding to the current driving speed according to a predetermined second positive proportional function; and
when the current driving speed is greater than a predetermined speed threshold, determining the overall loudness information based on torque information and the first loudness information.

6. The synthesis method according to claim 5, wherein the synthesis method further comprises:
when the current driving speed is not greater than the predetermined speed threshold, determining the first loudness information as the overall loudness information.

7. The synthesis method according to claim 5, wherein the step of determining the overall loudness information based on the torque information and the first loudness information comprises steps:
determining second loudness information corresponding to the torque information according to a predetermined third positive proportional function, wherein the second loudness information is not greater than 0;
performing summation calculation on the first loudness information and the second loudness information to obtain the overall loudness information.

8. The synthesis method according to claim 5, wherein the step of generating the to-be-output sound wave audio based on the processed audio samples in different frequency bands, the sample proportion information, and the overall loudness information comprises
respectively determining single-band loudness information corresponding to each of the processed audio samples according to the sample proportion information and the overall loudness information corresponding to different frequency bands; and
generating the to-be-output sound wave audio according to the processed audio samples satisfying the sample proportion information and corresponding single-band loudness information.

9. The synthesis method according to claim 1, wherein the at least one synthesized sound wave output instruction comprises synthesized sound wave output instructions, the at least one in-vehicle loudspeaker comprises in-vehicle loudspeakers, and the step of generating the at least one synthesized sound wave output instruction based on the to-be-output sound wave audio and sending the at least one synthesized sound wave output instruction to the at least one in-vehicle loudspeaker comprises:
correspondingly reconfiguring proportions of the processed audio samples in different frequency bands in the to-be-output sound wave audio according to frequency response characteristic information of the in-vehicle loudspeakers to obtain single-loudspeaker sound wave audios;
generating the synthesized sound wave output instructions based on the single-loudspeaker sound wave audios; and
simultaneously sending the synthesized sound wave output instructions respectively corresponding to the in-vehicle loudspeakers to the in-vehicle loudspeakers.

10. A synthesis device of a vehicle sound wave, comprising: a sample acquisition module, a frequency conversion processing module, an information determination module, an audio generation module, and an output control module;
wherein the sample acquisition module is configured to acquire a first sound wave audio sample corresponding to a current driving speed of a vehicle for frequency division processing to obtain second sound wave audio samples in different frequency bands;
wherein the frequency conversion processing module is configured to respectively perform frequency conversion processing on the second sound wave audio samples to obtain processed audio samples in different frequency bands;
wherein the information determination module is configured to determine sample proportion information of different frequency bands according to the current driving speed of the vehicle, and determining overall loudness information according to the current driving speed of the vehicle;
wherein the audio generation module is configured to generate a to-be-output sound wave audio based on the processed audio samples in different frequency bands, the sample proportion information, and the overall loudness information;
wherein the output control module is configured to generate at least one synthesized sound wave output instruction based on the to-be-output sound wave audio and send the at least one synthesized sound wave output instruction to at least one in-vehicle loudspeaker;
wherein the at least one synthesized sound wave output instruction is configured to control the at least one in-vehicle loudspeaker to play the to-be-output sound wave.

11. An electronic device, comprising:
a memory; and
at least one processor;
wherein the at least one processor is configured to execute computer programs stored in the memory; when the at least one processor executes the computer programs to implement the steps of the synthesis method according to claim 1.

12. A computer-readable storage medium, comprising computer programs stored therein;
wherein the computer programs are executed by at least one processor to implement the steps of the synthesis method according to claim 1.
